(19) United States
(12) Patent Application Publication
(10) Pub. No.: US 2003/0021945 A1
(43) Pub. Date: Jan. 30, 2003

(54) High-frequency active polymeric compositions and films

(76) Inventor: Robert H. Kelch, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/146,520

(22) Filed: May 15, 2002

Related U.S. Application Data
(60) Provisional application No. 60/298,564, filed on Jun. 15, 2001.

(51) Int. Cl. B05D 1/14; B32B 33/00; C08F 8/12; B32B 27/32

(52) U.S. Cl. 428/90; 442/398; 525/383

(57) ABSTRACT

High frequency (HF)-active compositions having a dielectric loss factor of 0.05 or more at 27 MHz and 23° C. contain a blend of a low molecular weight copolyester and a carboxyl-containing polyolefin, where to copolyester is present at a concentration of 20-80 weight-percent of the composition. The compositions are useful for making HF-active films and articles containing such HF-active films.

### CROSS REFERENCE STATEMENT

This application claims the benefit of U.S. Provisional Application No. 60/298,564, filed Jun. 15, 2001.

### BACKGROUND OF THE INVENTION

1. Field of the Invention

The present invention relates to high-frequency (HF) active polymer compositions, films, and articles prepared therefrom.

2. Description of Related Art

HF welding is useful in textile lamination, flexible packaging, flexible bag production, and in producing automotive components such as headliners and sunvisors. HF welding is an alternative to conventional heat-bonding methods for adhering a film to a substrate such as the film itself, another film, or a textile fabric. HF welding involves heating only a HF-active component or HF-active layer of a film structure sufficiently to soften that component. In contrast, conventional heat-bonding methods require transferring heat through an entire film structure to soften a bonding layer or component in the film. In each case, the softened layer or component subsequently bonds the film structure to a substrate.

HF welding is advantageous over conventional heating-bonding methods for at least three reasons. First, HF welding can bond a film in a fraction of the time required for conventional heating-bonding methods. Second, HF welding is less likely to degrade thermally sensitive material, such as oriented films and thermally sensitive dyes, than conventional heat-bonding methods. Third, bonding complex shapes is possible using HF welding with minimal difficulty relative to conventional heat-bonding methods.

Flexible polyvinyl chloride (f-PVC) enjoys a long history of use in HF-active films due to its HF sealing capability, vapor and gas barrier properties, and flexibility. Films of f-PVC contain a plasticizer, typically a phthalate plasticizer, to enhance film flexibility. The plasticizer can migrate out of the polymer over time, decreasing film flexibility. A desire for long term flexibility and concern about the environmental impact of halogenated polymers, such as f-PVC, make an alternative HR-active polymer to f-PVC desirable.

Other polymers useful for preparing films include polyolefin polymers and copolymers, styrenic block copolymers (SBC), ethylene-styrene interpolymers (ESI), and thermoplastic polyurethanes (TPU). However, each of these polymers has drawbacks as an alternative to f-PVC. Most polyolefin polymers, copolymers, and styrenic block copolymers are not HF-active. Incorporating HF-active fillers can increase the HF activity of such polymers, but at the expense of polymer properties such as tensile strength.

Olefin/acrylate copolymers and olefin/vinyl ester copolymers demonstrate HF activity when they contain greater than about 12 weight-percent (wt %) of a polar comonomer (e.g., acrylate or vinyl ester), based on copolymer weight. Such a high level of polar comonomer reduces a polymer's crystalline melting point (Tₘ) below 100 degrees Celsius (° C.), and generally below 90° C. Polymers having such a low Tₘ are not suitable for use in many articles where a film must maintain physical integrity through multiple exposures to temperatures around, an particularly above, 100° C. Examples of such articles include many textiles, such as clothing articles, which are subject to repeated washing and drying cycles. Additional examples of such articles include sun visors for automotive interiors. Olefin/acrylate and olefin/vinyl ester copolymers also tend to have a lower dielectric loss factor (DLF) than f-PVC. A lower DLF means more HF energy is necessary to HF weld the copolymers than f-PVC. Addition of HF-active fillers can help increase the DLF of a copolymer film, but at the expense of physical properties such as tensile strength.

TPUs generally have a suitable Tₘ and HF activity, but their cost is prohibitively high to make them a commercial alternative to f-PVC.

Commercially cost effective HF-active film forming polymer compositions and HF-active films that have long-term flexibility and a Tₘ greater than 90° C. are desirable as alternatives to f-PVC compositions and films. Preferably, the polymer compositions and films are also essentially halogen-free.

### BRIEF SUMMARY OF THE INVENTION

In a first aspect, the present invention is a polymer composition comprising a HF-active blend of a low weight-average molecular weight copolyester and a carboxyl-containing polyolefin, wherein said low weight-average molecular weight copolyester comprises 20-80 percent, by weight, of said polymer composition and wherein said polymer composition has a dielectric loss factor of 0.05 or more at 27 MHz and 23° C.

In a second aspect, the present invention is a polymeric film comprising the polymeric composition of claim 1. The polymeric film may contain more than one layer. Preferably, the film is HF-weldable.

In a third aspect, the present invention is an article of manufacture comprising the film of the second aspect, wherein said film is adhered to a woven or nonwoven textile.

### DETAILED DESCRIPTION OF THE INVENTION

Unless otherwise stated, each range includes endpoints used to define the range. Herein, “M_{w}” refers to weight-average molecular weight.

“HF-active” refers to a material having a DLF of 0.05 or more, preferably 0.1 or more as measured at a frequency between 0.1 and 30,000 megahertz (MHz) (the HF range), preferably 1-300 MHz (the radio-frequency (RF) range), most preferably 27 MHz. Calculate DLF values by multiplying a material's dielectric constant (DC) by its dielectric dissipation factor (DDF) (or loss tangent). Determine DC and DDF values using a Hewlett-Packard (HP) Impedance/Material Analyzer, model 4291B coupled with a HP Dielectric Test Fixture, model 16453A. Measure dielectric properties on compression molded plaques 2.5 inches (64 millimeters (mm)) in diameter and 0.05 inches (1.3 mm) thick at 23° C.

“HF-weldable”, “HF-sealable” are interchangeable terms and refer to compositions comprising an exposed HF-active component. For example, a HF-weldable film has HF-weldable material on an exposed film surface. The HF-active material may be a separate layer of the film or in the form of lines, strips, dots, or other patterns on the surface of the film. Preferably, the HF-active material is a separate layer.

Low M_{w} copolyesters are condensation products of one or more dicarboxylic acid (diacid) components and one or more di-alcohol (or glycol) components and have a M_{w} of 40,000 or less and, preferably, 10,000 or more. Low M_{w} copolyesters can be crystalline, semi-crystalline, or amorphous. Preferred diacids are terephthalic acid, isophthalic acid and adipic acid. Preferred glycols are aliphatic glycols such as ethylene glycol, butanediol and hexanediol. Low M_{w} copolyesters of the present invention have a DLF of 0.05 or more, preferably 0.1 or more when measured at 23° C. at a frequency in the HF range, preferably the RF range, most preferably when measured at 27 MHz. Low M_{w} copolyesters also have a melt flow rate (MFR) of 10 to 120 grams-per-10-minutes (g/10 min), preferably 10-65 g/10 min, at 160° C. (American Society for Testing and Materials (ASTM) method D1238 using a 2.16 kilogram (kg) load); a melt index rate (MI) of 20 to 300 g/10 min at 190° C. (ASTM method D1238 using a 2.16 kg load); a glass transition temperature (T_{g}) of −30° C. to 60° C. (ASTM method D-3418); a Tₘ (for crystalline and semi-crystalline materials) of 60° C. or more and 160° C. or less, preferably 100° C. or more, more preferably greater than 100° C. (ASTM method D-3418); a density of 1.2 to 1.3 grams per cubic centimeter (g/cm³) (ASTM method D-792); a Shore A durometer value of 30 to 99 and a Shore D durometer value of less than 60 (ASTM method D-2240); and a flexural modulus value when tested at 23° C. (ASTM method D-790) of less than 50,000 pounds-per-square-inch (psi) (345 megapascals (MPa)). Examples of suitable commercially available low M_{w} copolyesters include GRILTEX® (trademark of EMS-Chemie) and DYNAPOL® (trademark of Degussa-HULS) resins.

Low M_{w} copolyesters are particularly attractive in RF weldable compositions and films. The Tₘ range and flexural modulus range of low M_{w} copolyesters are similar to that of polyolefins, which facilitates compatibility between low M_{w} copolyesters and polyolefins. Low M_{w} copolyesters can have a sufficiently high Tₘ to be useful in applications requiring exposure to temperature up to and exceeding 100° C. Furthermore, low M_{w} copolyester have are inherently adhesive to polar substrates.

Low M_{w} copolyesters are distinguishable from high M_{w} polyesters and copolyesters. High M_{w} polyesters and copolyesters have a M_{w} of greater than 40,000 and a density of about 1.3 to 1.4 g/cm³. High M_{w} polyester and copolyesters have a higher flexural modulus of elasticity than low M_{w} copolyesters, with values greater than 200,000 psi (1,380 MPa) and typically greater than 300,000 psi (2,070 MPa). High M_{w} polyesters and copolyesters have a Shore D durometer value of greater than 95 (ASTM method D2240). Polyester terephthalate (PET) is a typical high M_{w} polyester. PET is a crystalline reaction product of terephthalic acid (TPA) or dimethyl terephthalate (DMT) and ethylene glycol (EG). Replacing some of the EG in PET with another glycol, such as cyclohexanedimethanol (CHDM), or by replacing some of the TPA with another diacid, such as isopthalic acid produces a semicrystalline copolymer of PET. PET and copolymers of PET generally have a Tₘ of about 200° C. to 250° C. Further glycol substitution of a PET copolymer using two or more glycols, such as EG and CHDM, produces a high M_{w} amorphous PET copolyester. Amorphous PET copolyesters do not exhibit a Tₘ, but do exhibit a glass transition temperature (T_{g}) of about 80° C. to 100° C. Examples of high M_{w} copolyesters include those known as “PETG”, “PCTA”, and “PCTG”.

Low M_{w} copolyesters are also distinguishable from copolyester thermoplastic elastomers (also known as copolyester-ether elastomers). Copolyester thermoplastic elastomers are high M_{w} (M_{w} greater than 40,000) semicrystalline block copolymers consisting of a crystalline hard segment and a soft amorphous segment. Copolyester thermoplastic elastomers have Tₘ values higher than 150° C., Shore D durometer values of 30-85, flexural modulus values of about 5,000 psi (35 MPA) to about 100,000 psi (690 MPa). Copolyester thermoplastic elastomers are commercially available as polybutylene terephthalate (PBT) and polyether glycol copolymers known as HYTREL® (trademark of E. I. du Pont de Nemours & Company) elastomers; dimethylcyclohexane dicarboxylate, cyclohexane dimethanol, polytetramethylene glycol copolymers known as ECDEL® (trademark of Eastman Chemical Company) elastomers; and RITEFLEX® (trademark of Hoechst Celanese Corporation) elastomers.

The present polymer compositions include at least one carboxyl-containing polyolefin blended with the low M_{w} copolyester. The carboxyl-containing polyolefin is either crystalline or semi crystalline and tends to enhance tensile impact and tear strength and reduce tackiness of the polymer composition relative to low M_{w} copolyesters alone. Carboxyl-containing polyolefins, particularly carboxyl-containing ethylene copolymers, facilitate production of films from the present polymer compositions using conventional film, sheet, profile and tubing extrusion equipment. The carboxyl-containing polyolefins also impart increased adhesion to non-polar polymers and copolymers, such as polyethylene (PE) and polypropylene (PP), relative to low M_{w} copolyesters alone.

Carboxyl-containing polyolefins contain a polyolefin backbone containing functionalities selected from carboxyl groups and carboxyl ester groups. Carboxyl and carboxyl ester groups have the following structure:

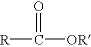

Either R or R′ attaches to the polyolefin backbone directly or through a carbon containing group (such as methylene or ethylene). The other of R and R′ is H or a carbon containing group, preferably H, methyl, ethyl, propyl, or butyl.

Carboxyl-containing polyolefins are preferably ethylene-based. Ethylene-based polymers have a polymer backbone comprising multiple polymerized ethylene monomer units. Carboxyl-containing polyolefins generally have a density of 0.86 to 1.03 grams-per-cubic-centimeter (g/cm³), preferably 0.89 g/cm³ or greater and 0.97 g/cm³ or less (ASTM method D-792). Carboxyl-containing polyolefins also generally have a MI of 0.5 to 300 g/10 min, preferably 1 to 100 g/10 min, more preferably 2 to 20 g/10 min (ASTM method D-1238 at 190° C. using a 2.16 kg load).

Suitable carboxyl-containing polyolefins include acid functionalized polyolefins. Acid functionalized polyolefins include polyolefins copolymerized with unsaturated carboxylic acid and polyolefins having carboxylic acid groups grafted therein. Suitable unsaturated carboxylic acids include acrylic acid (AA) and methacrylic acid (MAA). The concentration of acid functionality is adequate to render the polymer sufficiently compatible with a low M_{w} copolyester to form a polymer blend film. Acid functionalized polyolefins contain 3 wt % or more, preferably 6 wt % or more and 30 wt % or less, generally 20 wt % or less acid monomer relative to acid functionalized polyolefin weight. Examples of suitable acid functionalized polyolefins include ethylene/acrylic acid (EAA) copolymers such as PRIMACOR® resins (PRIMACOR is a trademark of The Dow Chemical Company); ethylene/methacrylic acid (EMAA) copolymers such as NUCREL® copolymers (NUCREL is a trademark of E. I. du Ponte de Nemours and Company); ethylene/methyl acrylate/acrylic acid terpolymers (EMAAA) such as ESCOR® ATX resins (ESCOR is a trademark of Exxon Mobile Corporation).

Suitable carboxyl-containing polyolefins also include ester functionalized polyolefins such as ethylene copolymerized with an alkyl ester of an ethylenically unsaturated organic carboxylic acid. Ethylene/vinyl acetate (EVA) copolymer, which comprises vinyl acetate (VA) copolymerized with ethylene, is one particularly preferred ester functionalized polymer. For use in the present invention, EVA desirably is 9 wt % or more, preferably 12 wt % or more, most preferably 15 wt % or more VA based on total EVA weight in order to impart sufficient blend compatibility with a low M_{w} copolyester. Generally, the concentration of VA is 40 wt % or less. EVA copolymers are commercially available as ELVAX® resin (ELVAX is a trademark of E. I. du Ponte de Nemours and Company); ESCORENE® resin (ESCORENE is a trademark of Exxon Mobile Corporation), ULTRATHENE® resin (ULTRATHENE is a trademark of Equistar Chemicals), and EVATANE® resin (EVATANE is a trademark of AtoFina). EVA copolymers may contain copolymerized or grafted monomers in addition to a carboxyl-containing monomer.

Suitable carboxyl-containing polyolefins further include acrylate modified polyolefins such as polymers copolymerized with a hydrocarbyl ester monomer of an ethylenically unsaturated organic carboxylic acid. Preferred hydrocarbyl ester monomers include methyl acrylate (MA), ethyl acrylate (EA), and n-butyl acrylate (nBA). The hydrocarbyl ester monomer preferably comprises 9 wt % or more, more preferably 12 wt % or more, and most preferably 15 wt % or more of the acrylate modified polyolefin. Increasing the amount of hydrocarbyl ester monomer in an acrylate modified polyolefin increases compatibility between the acrylate modified polyolefin and a low M_{w} copolyester, resulting in a more homogeneous polymer composition. Examples of suitable acrylate modified polyolefins include ethylene/methyl acrylate (EMA) (e.g., EMAC® (trademark of Eastman Chemical Company), ESCOR® and OPTIMA® (trademarks of Exxon Mobile Corporation), ELVALOY® AC (trademark of E. I. Du Ponte de Nemours and Company) and LOTRYL (available from AtoFina) resins, ethylene/ethylacrylate (EEA) (e.g., ELVALOY AC EEA resins), ethylene/n-butyl acrylate (e.g., EBAC® resin (EBAC is a trademark of Eastman Chemical Company), EMAAA (e.g., ESCOR ATX resins), and ethylene/methyl or ethyl acrylate/maleic anhydride terpolymers (e.g., LOTADER® resins, LOTADER is a trademark of AtoFina).

Carboxyl-containing polyolefins may further contain anhydride functionality. Typically, anhydride functionality on a polymer is the result of grafting an ethylenically unsaturated carboxylic acid anhydride, such as maleic anhydride (MAH) onto a polymer backbone. PE, PP, and ethylene copolymers such as EVA serve as suitable backbone polymers. Typical MAH-grafted (MAH-g) polyolefins contain from 0.05 to 1.5 wt % MAH based on total polymer weight. Compositions containing MAH-g polyolefins tend to demonstrate stronger adhesion to themselves after HF-welding than compositions without MAH-g polyolefins. Commercially available MAH-g polyolefins include BYNEL® CXA (BYNEL is a trademark of E. I. du Pont de Nemours and Company), FUSABOND® (trademark of DuPont Canada, Inc.), and PLEXAR® (trademark of Equistar Chemicals, LP) and LOTADER resins.

Within the present invention, carboxyl-containing polyolefins typically comprise 80 wt % or less, preferably 70 wt % or less, and typically 10 wt % or more, preferably 20 wt % or more of a polymer composition weight. The concentration of low M_{w} copolyester in the polymer composition is sufficient to render the polymer composition HF-active. Polymer compositions of the present invention preferably comprise 20 wt % or more, more preferably 30 wt % or more and preferably 90 wt % or less, more preferably 80 wt % or less low M_{w} copolyester, based on polymer composition weight. Polymer compositions having less than 20 wt % of a low M_{w} copolyester tend to have of a DLF less than 0.05. Polymer compositions containing more than 90 wt % of a low M_{w} copolyester tend to have undesirable tensile impact values, undesirable tear strength, and undesirable adhesion to non-polar polymers.

Polymer compositions desirably are crystalline or semi-crystalline in nature (i.e., polymer compositions comprised of polymers having a Tₘ) and have a weight-average Tₘ of 90° C. or higher, preferably 100° C. or higher, still more preferably higher than 100° C. A weight-average Tₘ for a polymer composition is a sum of normalized Tₘ values for each polymer in the composition. A normalized Tₘ value is a polymer's Tₘ divided by the polymer's concentration in the polymer composition (in wt % relative to polymer composition weight). Polymer compositions generally include sufficient crystalline or semi-crystalline low M_{w} copolyester having a Tₘ higher than 100° C. to result in a weight-average Tₘ for the polymer composition that is higher than 100° C. Polymer compositions having a weight-average Tₘ higher than 100° C. are particularly useful in making HF-active films for applications requiring exposure to elevated temperatures such as textile laminates (which require repeated washing and drying) and automotive interiors.

Polymer compositions of the present invention may contain polymers in addition to the low M_{w} copolyester and carboxyl-containing polyolefin. Additional polymers are useful for modifying properties of films prepared from a polymer composition. Suitable additional polymers include olefinic homopolymers and copolymers such those selected from a group consisting of PE (e.g., low density PE (LDPE), linear low density PE (LLDPE), ultra low density PE (ULDPE), and PE plastomer), branched and linear PP, ethylene/styrene interpolymer (ESI), ethylene/vinyl alcohol (EVOH), polybutene, polyisobutene, styrene/butadiene block copolymer, styrene/isoprene/styrene block copolymer, cyclic olefin copolymers, and fully hydrogenated olefin-styrene block copolymers, and MAH-g olefin polymers such as MAH-g EVA, MAH-g PE, and MAH-grafted PP, and MAH-g styrenic block copolymers. Additional polymers can comprise up to about 50 wt % of the polymer composition.

Polymer compositions of the present invention may contain at least one conventional additive. Suitable conventional additives include those selected from a group consisting of antioxidants, process stabilizers, ultraviolet stabilizers, tackifiers, fire retardants, inorganic fillers, biocides, and pigments. Conventional additives generally comprise up to about 30 wt % of the polymer composition. Preferably, additives are present at a sufficiently low concentration so as to not detrimentally affect desired polymer composition properties, such as tensile strength.

Polymer compositions of the present invention are HF-active in the absence of HF-active fillers. Nonetheless, the polymer compositions may contain at least one HF-active filler as an additive to enhance HF-activity or to modify some other property of the composition. Examples of HF-active fillers include aluminum trihydrate, magnesium hydroxide, and sodium alumninosilicate.

The copolyester, carboxyl-containing polyolefins, additional polymers, and conventional additives together comprise essentially 100 wt % of the polymer composition. “Essentially 100 wt %” means greater than 95 wt %, preferably greater than 98 wt %, more preferably greater than 99 wt %, most preferably 100 wt %.

Polymer compositions of the present invention are particularly well suited for preparing HF-active films. HF-active films are sealable or weldable to themselves or other substrates using a conventional HF process with a HF welder, preferably an RF welder. HF welders include RF welders and microwave welders. Commercially available HF welders include those available from Callanan Company (Alloyd RF Sealing Systems), Weldan, Colpitt, Kiefel Technologies, Thermatron, and Radyne. RF welders typically operate at a frequency of 27.12 MHz, 13.56 MHz, or 40.68 MHz. Microwave welders may also be suitable for welding or sealing films of the present invention and typically operate at a frequency of 2.45 gigahertz (GHz), 5.87 GHz, or 24.12 GHz. HF welding of films of the present invention generally involves operating a HF sealing apparatus with a die or tooling temperature set at 23° C. or higher. Increasing the die or tooling temperature can improve HF activation of the HF-active polymer composition, thereby reducing seal time. Die or tooling temperatures can be 40° C. or higher, even 60° C. or higher, but are generally 120° C. or lower for HF welding films of the present invention. Die or tooling temperatures higher than the weight-average Tₘ of a film usually heat-seal or melt-weld the film to a substrate and are generally higher than is necessary for HF welding.

Any conventional film forming process is suitable for fabricating HF-active films of the present invention from a polymer composition of the present invention. Illustrative processes include annular extruded blown film processes, slot die cast extrusion film processes, and extrusion coating of at least one layer upon a film or substrate. Films of the present invention can be monolayer films or multilayer films. Multilayer films comprise at least two layers wherein at least one layer is HF-active. Illustrative processes for preparing multilayer films includes coextrusion and lamination. Tubular profiles of HF-active films are also within the scope of the present invention. Tubular profiles are useful for forming HF-active tubing suitable for thermally welding or HF welding to HF active films to form, for example, medical collection bags, infusion bags, and other liquid containment or inflatable devices that require tubing attachments.

HF-active films of the present invention can be of any gauge. Typically, the gauge is 1-100 mils (25-2500 micrometers (μm)), preferably 2-20 mils (50-500 μm). The HF-active films preferably exhibit tensile strengths in the machine direction (MD) and transverse direction (TD) of greater than 2,000 psi (14 MPa), ultimate elongations of greater than 400%, and 2% secant modulus values of 4,000 psi (28 MPa) to 30,000 psi (207 MPa) when tested according to ASTM method D-882. More preferably, the HF-active films further exhibit MD and TD Elmendorf tear strengths of greater than 200 grams/mil (8 grams/μm) when tested according to ASTM method D-1922. Films having these aforementioned properties are sufficiently durable for subsequent conversion operations (e.g., thermal lamination and HF-welding) and for end use applications such as medical bags, textile laminates, and automotive interior laminates.

A preferred embodiment of the present invention is a HF-weldable multilayer film comprising an exposed HF-active polymer layer and a HF-inactive (DLF value less than 0.05) and/or weakly HF-active (DLF of 0.05-0.1) layer. Such a multilayer film is HF-weldable by means of the exposed HF-active layer. Especially preferred multilayer films of the present invention have “AB”, or “ABA” structures, wherein “A” corresponds to a HF-active layer and “B” corresponds to a HF-inactive or weakly HF-active. “ABC” -type structures are also suitable, wherein “C” is an HF-inactive or weakly active layer different from “B”. Any number of different or repeated layers are conceivable within the scope of this invention, provided at least one layer, preferably at least one exposed layer, is HF-active.

HF-active films of the present invention may include at least one adhesive layer. Adhesive layers may be, for example polar-functional ethylene copolymers such as EVA, EEMA, EVA-grated MAH, EAA, or conventional low M_{w} thermoplastic adhesives such as copolyester, copolyamide or polyurethane. Additionally, HF-active films may contain conventional liquid applied emulsions or dispersions. The emulsions or dispersion may be aqueous or solvent borne, thermoplastic or thermosetting. Adhesive layers are useful for bonding materials to HF-active films while, desirably, while preserving an exposed HF-active layer.

HF-seals between films of the present invention and either themselves or substrates typically have an adhesive strength of at least 4 pounds-per-inch (lb/in) (0.72 Newtons-per-millimeter (N/mm)), preferably at least 6 lb/in (1.05 N/mm), and most preferably at least 8 lb/in (1.4 N/mm) according to a 180 degree peel test (ASTM method D-903). Multilayer films of the present invention desirably demonstrate a similar adhesive strength between layers of the multilayer film.

Films of the present invention are also capable of thermal lamination, sealing, and welding using conventional thermal processes such as hot roll lamination, flame lamination, and heat sealing. A combination of a thermal process with a HF process is also feasible. For example, thermally laminating a film of the present invention to a substrate such as a fabric can form a film/fabric composite. HF-welding two such film/fabric composites together at a film/film interface (or folding the same film/fabric composite back on itself to form a film/film interface) can provide a fabric/film/fabric composition. Additional substrates of interest include cellular foams (e.g., polyurethane, polystyrene, and polyolefin foams), woven and non-woven fabrics, paper and paperboard products, thermoplastic film and sheet, wood veneer and wood products, and wood and cellulosic composites.

HF-active films of the present invention have many uses. For example, layering two sheets of HF-active film, or folding the same HF-active film onto itself and HF-sealing around a perimeter of the sheet(s) forms a bag or a pouch. Such bags can be suitable for medical applications such as fluid delivery bags or liquid waste collection bags, liquid containment, gel packages such as for hot packs and colds packs, and beverage containment pouches.

One particularly useful application is for manufacturing designs capable of being laminated onto clothing. Films of the present invention exhibit a desirable temperature resistance, water and detergent resistance, flexibility, elasticity, and adhesion to fabrics and textiles, making them well suited for clothing applications such as adhesive interlinings, stitched seam taping or-water-resistant coatings.

HF-active films of the present invention may be flocked films, that is they containing short fibers adhered to a surface of the HF-active film. For example, HF-active flocked films generally contain a liquid adhesive disposed on a surface of a HF-active film with flocking fiber disposed on a surface of the adhesive remote from the HF-active film. Drying or curing the adhesive bonds the flocking fiber to the HF-active film. Suitable flocking fibers include polyester, nylon, rayon, or other natural or synthetic fibers that are generally about 0.5 mm or greater in length. Suitable liquid adhesives include aqueous and solvent-borne thermoplastic or thermosetting adhesives. Such adhesives often are based on acrylic, urethane, epoxy, or polyvinyl acetate chemistry. Desirably, flocked films contain flocking on one surface and an HF-active layer on an opposing surface. HF-welding can adhere such a flocked film to a woven or non-woven substrate, such as a garment. One particularly useful application for HF-active flocked films is in preparing athletic apparel or decorative clothing with flocked film designs HF welded thereon. Flocked HF-active films generally have a felt-like or velour-like feel on the flocked surface.

HF-active films of the present invention having a weight-average Tₘ of greater than 100° C. are particularly well suited for high temperature applications including automotive interior lamination, especially to woven or nonwoven textiles. Automotive sunvisors, for example, can comprise a HF-active film thermally laminated to a fabric to form a film/fabric composition, with the film/fabric composition HF welded around a rigid core. Additionally, film/fabric laminates containing films of the present invention are useful in fabricating into headliner structures, door panels, seating covers, and carpet mats.

The following examples serve to further illustrate aspects of the present invention and do not limit the scope in any way.

Table 1 lists DLF, Tₘ, flexural modulus, Shore A durometer, MI, and MFR values for exemplary commercially available copolyesters suitable for the present invention. Determine the value in Table 1 according to methods mentioned above. “NM” means the value was not measured. The examples following Table 2 use GRILTEX D1519E (CoPET1) and GRILTEX 9G (CoPET2) low M_{w} copolyesters.

TABLE 1

| Co- | | | Flexural | | MI | MFR |
|---|---|---|---|---|---|---|
| polyester | | Tₘ | Modulus | Shore A | (190° C., | (160° C., |
| Resin | DLF | (° C.) | (psi) | Durometer | 2.16 kg) | 2.16 kg) |
| Griltex | 0.09 | 125 | 19,000 | 96 | 36 | 12 |
| D1519E | | | | | | |
| (CoPET1) | | | | | | |
| Griltex | 0.12 | 110 | 25,300 | 93 | NM | 21 |
| D1442E | | | | | | |
| Griltex 9G | 0.08 | 120 | 5,300 | 95 | 125 | 40 |
| (CoPET2) | | | | | | |
| Griltex | NM | 125 | 23,900 | 85 | NM | 78 |
| D1441E | | | | | | |
| Griltex | 0.13 | 150 | 36,000 | 95 | 117 | NM |
| D1309E | | | | | | |

Table 2 lists exemplary commercially available carboxyl-containing polyethylenes and their comonomer ratio, Tₘ, and MI. The following examples use carboxyl-containing polyethylenes.

TABLE 2

| Carboxyl-Containing | | Tₘ | MI |
|---|---|---|---|
| Polyolefin | % Comonomer | (° C.) | (190° C., 2.16 kg) |
| Elvax 3190 | 25% VA | 77 | 2 |
| (EVA1) | | | |
| Elvax 3175 | 28% VA | 73 | 6 |
| (EVA2) | | | |
| Bynel 3861 | ·24% VA + | 80 | 2 |
| (EVA-MAH1) | graft MAH | | |
| Bynel E-418 | ·28% VA + | 74 | 11 |
| (EVA-MAH2) | graft MAH | | |
| SP2260 | 24% MA | 76 | 2 |
| (EMA1) | | | |
| Primacor 1430 | 9.7% AA | 96 | 5 |
| (EAA1) | | | |

### EX 1

### Monolayer Film and HF Seal Testing

Prepare Ex 1 using a conventional slot die cast film line with a 2.5 inch (6.4 cm) diameter, 24:1 length-to-diameter ratio (L/D) single screw extruder operating with ramped extruder zone temperatures of 280° Fahrenheit (° F.) (138° C.) to 330° F. (165° C.) and a 28 inch (71 cm) wide slot die operating at temperatures of 330° F. (165° C.) to cast a melt-processible polymer composition onto a chilled 70° F. (21° C.) casting roll, forming an eight (8) mil (200 μm) thick monolayer film. Wind the film into a roll. Optionally, corona treat a surface of the monolayer film to increase surface energy prior to winding.

The melt-processible polymer composition comprises 60 wt % CoPET1, 30% EVA1, 5 wt % LDPE (LDPE 4012, The Dow Chemical Company, density of 0.918 g/cm³, MI of 12) and 5 wt % of CN-734 antiblock concentrate (Southwest Plastics, 15 wt % SiO₂ and 85 wt % LDPE), based on polymer composition weight. Ex 1 has a DLF of 0.07. Table 3 contains physical property values for Ex 1. Measure properties in both machine direction (MD) and transverse direction (TD) according to ASTM methods D-882 and D-1922. Herein “>” means “greater than”.

TABLE 3

| Property | MD | TD |
|---|---|---|
| Ultimate Tensile Strength | 3,700 | 3,100 |
| (psi/(MPa)) | (26) | (21) |
| Ultimate Elongation | 530 | 530 |
| (%) | | |
| 2% Secant Modulus | 13,600 | 12,600 |
| (psi (N/square mm)) | (94) | (87) |
| Elmendorf Tear Strength | >810 | >780 |
| (gram/mil (gram/μm)) | (>32) | (>31) |

HF-seal two plies of Ex 1 together using a Callanan 2.0 kilowatt (kW) RF welding machine operating at 70% power setting fitted with a non-heated 0.5 inch (1.25 cm) wide by eight (8) inch (20.3 cm) long bar seal die and with a 0.5 second low power preheat and 2.5 second RF seal time followed by one (1) second dwell time (no power) and a Clayton air capacitor plate setting adjusted to 16. Cut the film into five (5) strips one (1) inch (2.5 cm) wide. Subject the strips to 180° peel testing using an Instron tensile tester at a pull rate 12 inch/minute (30.5 cm/minute) at 23° C., in accordance with ASTM method D-903. An average adhesion strength for the five (5) samples is 9.6 pounds/inch (lb/in) (1.7 Newtons/millimeter (N/mm)).

Ex 1 illustrates a film of the present invention that is readily HF welded to form a film-to-film seal and is sufficiently durable for subsequent conversion operations and end use applications.

### EX 2-10

### Monolayer film Series and HF Seal Testing

Prepare a series of monolayer copolyester/carboxyl-containing polyolefin blend films (Ex 2-10) having different weight ratios of low M_{w} copolyester to carboxyl-containing polyolefin. Prepare the films on a conventional cast film line using a one (1) inch (2.5 cm) diameter extruder feeding into a 10 inch (25 cm) wide slot die. Ramp the extruder zone temperatures from 280° F. (138° C.) to 320° F. (160° C.) with the die operating at 320° F. (160° C.). Each of the films additionally contains five (5) wt % of CN734 antiblock concentrate, based on copolyester/carboxyl-containing polyolefin blend weight. Extrude all blends into uniform films that are eight (8) mils (200 μm) thick.

For each Ex prepare five (5) samples. For each sample, HF-seal two plies of a film together using the same conditions as in Ex 1, but with a Clayton air capacitor plate setting between 15 and 17. The average HF weld strength of the five (5) samples for each Ex is >4.0 lb/in (0.7 N/mm). Film compositions and average HF weld strengths, as tested by ASTM D-903, are given in Table 4.

Table 4 also contains properties of the polymer compositions of Ex 2-10. Measure MI, Shore A Durometer and DLF using a plaque made from each Ex. Prepare each plaque using a heated platen press operating at 350° F. (1779° C.) by stacking multiple plies of each Ex together and melt pressing into a 0.050 inch (1.3 mm) thick plaque.

TABLE 4

| | | Average HF | | | MI | Weight- |
|---|---|---|---|---|---|---|
| | | Weld Strength | | Shore A | (190° C., | Average |
| Film | Composition | lb/in (N/mm) | DLF | Durometer | 2.16 kg) | Tₘ (° C.) |
| Ex 2 | 80 wt % CoPET1 | 11 | 0.07 | 95 | 26 | 115 |
| | 20 wt % EVA1 | (1.9) | | | | |
| Ex 3 | 60 wt % CoPET1 | 8 | 0.07 | 95 | 15 | 106 |
| | 40 wt % EVA1 | (1.4) | | | | |
| Ex 4 | 40 wt % CoPET1 | 5 | 0.07 | 91 | 7 | 96 |
| | 60 wt % EVA1 | (0.9) | | | | |
| Ex 5 | 20 wt % CoPET1 | 5 | 0.07 | 89 | 3 | 87 |
| | 80 wt % EVA1 | (0.8) | | | | |
| Ex 6 | 40 wt % CoPET1 | 6 | 0.07 | 91 | 7 | 98 |
| | 60 wt % EVA-MAH1 | (1.0) | | | | |
| Ex 7 | 60 wt % CoPET1 | 11 | 0.07 | 92 | 16 | 107 |
| | 40 wt % EVA-MAH1 | (1.9) | | | | |
| Ex 8 | 40 wt % CoPET2 | 8 | 0.07 | 91 | 17 | 92 |
| | 60 wt % EVA2 | (1.4) | | | | |
| Ex 9 | 40 wt % CoPET2 | 11 | 0.06 | 92 | 22 | 92 |
| | 60 wt % EVA-MAH2 | (1.9) | | | | |
| Ex 10 | 60 wt % CoPET2 | 15 | 0.05 | 94 | 37 | 102 |
| | 40 wt % EVA-MAH2 | (2.6) | | | | |

Ex 2-5 illustrate HF-active films having a breadth low M_{w} copolyester to carboxyl-containing polyethylene ratios (80:20 that fall within the scope of the present invention.

Ex 6-7 illustrate HF-active films having MAH grafting that fall within the scope of the present invention.

A comparison of Ex 3 to Ex 7 and 10, and Ex 8 to Ex 9, reveals higher adhesion strengths for compositions containing MAH-g EVA relative to just EVA.

### EXAMPLE 11

### Coextruded Multilayer Film

Coextrude a symmetrical 3-layer, eight (8) mil (200 μm) thick film having an “ABA” structure using a conventional slot die cast film line equipped with a two (2) inch (5.0 cm) diameter 24:1 L/D extruder feeding the “A” skin layer and a

Conduct 180 degree peel testing, as described for Ex 1, on each Ex at both 23° C. and 60° C. to determine 2-ply laminate adhesion. Peel test results are in Table 6.

TABLE 6

| | 2-Ply Laminate Adhesion | 2-Ply Laminate Adhesion | |
|---|---|---|---|
| | Adhesion at 23° C. | at 60° C. | |
| Sample | (lb/in/N/mm) | (lb/in/N/mm) | |
| Ex 12 | 12 (2.1) | 8 | (1.4) |
| Ex 13 | 17 (3.0) | 5 | (0.9) |
| Comp Ex A | 18 (3.2) | 0.1 | (0) |

Comp Ex A (EVA film) loses essentially all of its 2-ply laminate adhesion (peel strength) at 60° C. In contrast, Ex 12-13 retain at least 5 lb/in (0.9 N/mm) peel strength at 60° C. Therefore, structures welded together with Comp Ex A would have less integrity at 60° C. than structures welded together with either Ex 12 or Ex 13.

What is claimed is:

1. A polymer composition comprising a HF-active blend of a low weight-average molecular weight copolyester and a carboxyl-containing polyolefin, wherein said low weight-average molecular weight copolyester comprises 20-80 percent, by weight, of said polymer composition and wherein said polymer composition has a dielectric loss factor of 0.05 or more at 27 MHz and 23° C.

2. The polymer composition of claim 1, wherein said polymer composition has a weight-average crystalline melting point of 90° C. or higher when individual polymers in said composition are tested according to ASTM method D-3418.

3. The polymer composition of claim 1, wherein said low weight-average molecular weight copolyester has a melt flow rate of 10 to 65 g/10 minutes at 160° C. when tested according to ASTM method D1238 using a 2.16 kg load.

4. The polymer composition of claim 1, wherein said low weight-average molecular weight copolyester has a crystalline melting point of higher than 100° C.

5. The polymer composition of claim 1, wherein said low weight-average molecular weight copolyester has a dielectric loss factor of 0.05 or more at 27 megahertz and 24° C.

6. The polymer composition of claim 1, wherein said carboxyl-containing polyolefin has a melt index value of 2 to 20 g/10 min when tested according to ASTM method D-1238 at 190° C. using a 2.16 kg load.

7. The polymer composition of claim 1, wherein said carboxyl-containing polyolefin has a density of 0.86 to 1.03 g/cm³ when tested according to ASTM method D-792.

8. The polymer composition of claim 1, wherein said carboxyl-containing polyolefin is ethylene-based.

9. A polymeric film comprising the polymeric composition of claim 1.

10. The film of claim 9, wherein said film is HF-weldable.

11. The film of claim 9, wherein said film is a multilayer film and at least one layer comprises the polymeric composition of claim 1.

12. The film of claim 11, further comprising flocking on one surface of said polymeric film and an HF-active layer on an opposing surface.

13. An article of manufacture comprising the film of claim 9, wherein said film is adhered to a woven or nonwoven textile.

14. The article of manufacture of claim 13, wherein, said film has been thermally laminated to a woven or nonwoven textile.

15. The article of manufacture of claim 13, wherein said film is a flocked film.
